(19) United States
(12) Patent Application Publication
(10) Pub. No.: US 2011/0075431 A1
(43) Pub. Date: Mar. 31, 2011

(54) Heat dissipation structure for LED lamp

(76) Inventor: Tsu-Yao Wu, Taipei City (TW)

(21) Appl. No.: 12/585,918

(22) Filed: Sep. 29, 2009

(51) Int. Cl. F21V 29/00; F21V 21/00

(52) U.S. Cl. 362/373; 362/249.02

(57) ABSTRACT

A heat dissipation structure for LED lamp includes at least one mounting plate connected to and between a top and a bottom locating plate, and a roll-shaped heat radiating member arranged beneath the top locating plate. The mounting plate and the top and bottom locating plates each are provided with a metal layer, to which LEDs are welded. When the heat dissipation structure is assembled to a lamp holder to form an LED lamp and the LEDs are lightened, heat produced by the LEDs is radiated from the metal layers and the heat radiating member, which together provide a large heat radiating area; meanwhile, perforations on the top locating plate allow convection of air in the LED lamp, and openings provided on the lamp holder allow exchange of air inside and outside the LED lamp, allowing the LED lamp to have reduced volume and increased heat dissipation efficiency.

### FIELD OF THE INVENTION

The present invention relates to a heat dissipation structure for LED lamp, and more particularly to an LED lamp heat dissipation structure that has simple structure and small volume to enable the LED lamp to have reduced volume, good heat dissipation effect, and lowered manufacturing cost.

### BACKGROUND OF THE INVENTION

The light-emitting-diode (LED) lamp, due to its low power consumption and high brightness, has been widely developed and applied to various kinds of products in recent years. However, LEDs in working would produce a large amount of heat, which would adversely affect the service life of the LEDs or even cause burnout of the LEDs. Therefore, most of the conventional LED lamps are provided with a heat dissipation structure to dissipate the heat produced by the working LEDs, so as to maintain the LEDs in normal operation. Conventional heat dissipation structure for LED lamp often includes large-area aluminum radiating fins to dissipate the largest part of the produced heat. These large-area aluminum radiating fins prevent the LED lamp from having a small volume and produce heat concentration effect, and are therefore not the best way for heat dissipation. Moreover, the large-volume aluminum radiating fins disadvantageously require high cost.

It is therefore tried by the inventor to develop an improved LED lamp heat dissipation structure that is simple, low cost, and small in volume.

### SUMMARY OF THE INVENTION

A primary object of the present invention is to provide a heat dissipation structure for LED lamp, so that the LED lamp has simple heat dissipation structure to enable reduced manufacturing cost, reduced lamp volume, increased heat dissipation effect, and accordingly, increased competing ability in the market.

To achieve the above and other objects, the heat dissipation structure for LED lamp according to a preferred embodiment of the present invention includes one or more mounting plates, a bottom locating plate into which lower ends of the mounting plates are inserted, a top locating plate connected to upper ends of the mounting plates, and a heat radiating member arranged beneath the top locating plate. The mounting plate and the top and bottom locating plates each are provided with a metal layer, and a plurality of LEDs is welded at respective leads to the metal layers. The top locating plate and the metal layer thereof are provided with a plurality of tiny perforations.

When the heat dissipation structure is assembled to a lamp holder to form an LED lamp and the LEDs are lightened, heat produced by the LEDs during working is radiated from the metal layers on the mounting plates, the bottom locating plate and the top locating plate, and from the heat radiating member, which together provide a relatively large heat radiating area; meanwhile, the perforations provided on the top locating plate allow convection of air in the LED lamp, and openings and an annular space provided on the lamp holder allow exchange of air inside and outside the LED lamp, allowing the LED lamp to have simple heat dissipation structure, reduced volume, increased heat dissipation efficiency, and reduced manufacturing cost.

In the present invention, the mounting plates are circuit boards, and the metal layers thereof are printed circuits arranged on the circuit boards.

In the present invention, the metal layers can be provided on one single side or two opposite sides of the circuit boards to provide increased heat dissipation area.

In the present invention, the heat radiating member provided beneath the top locating plate is a long metal strip wound into a roll to provide increased heat radiating area within a small volume. And, by taking advantage of the expansion of the heated metal strip of the heat radiating member, good air convection in the LED lamp can be achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a heat dissipation structure for LED lamp according to a first embodiment of the present invention;

FIG. 2 is a top perspective view of an LED lamp with the heat dissipation structure of FIG. 1 assembled thereto;

FIG. 3 is a bottom perspective view of the LED lamp of FIG. 2;

FIG. 4 is a perspective view of a roll-shaped heat radiating member included in the present invention;

FIG. 5 is a phantom view showing the heat dissipation structure for LED lamp according to the first embodiment of the present invention in use; and

FIG. 6 is a phantom view showing an LED lamp with a heat dissipation structure according to a second embodiment of the present invention assembled thereto.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

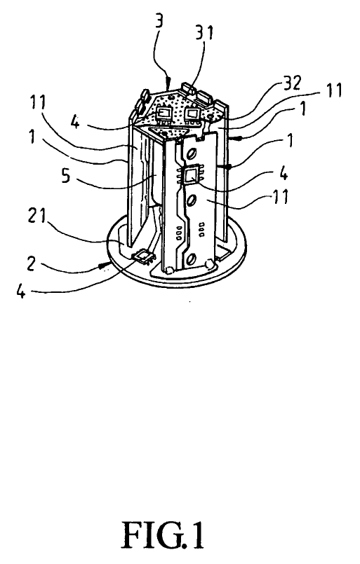

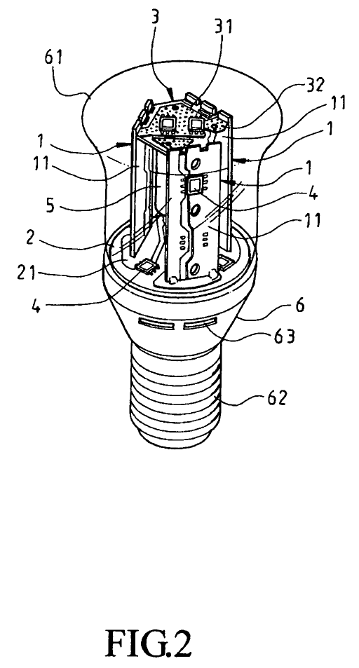

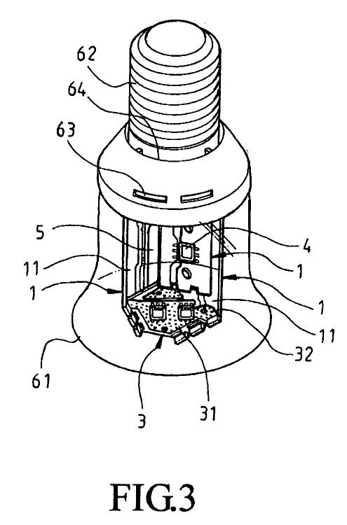

Please refer to FIG. 1 that is a perspective view of a heat dissipation structure for LED lamp according to a first embodiment of the present invention, and to FIGS. 2 and 3 that are top and bottom perspective view of an LED lamp with the heat dissipation structure of FIG. 1. As shown, the heat dissipation structure for LED lamp in the first embodiment includes one or more mounting plates 1, a bottom locating plate 2, into which lower ends of the one or more mounting plates 1 are inserted, a top locating plate 3 connected to upper ends of the one or more mounting plates 1, and a heat radiating member 5.

The one or more mounting plates 1 each are provided with a metal layer 11. A plurality of LEDs 4 is welded at respective leads to the metal layers 11 on the one or more mounting plates 1. In the illustrated first embodiment, the one or more mounting plates 1 are circuit boards, and the metal layers 11 are printed circuits arranged on the circuit boards; and the metal layers 11 can be provided on one single side or on two opposite sides of the circuit boards.

The bottom locating plate 2, into which lower ends of the one or more mounting plates are inserted, is provided with a metal layer 21. A plurality of LEDs 4 is welded at respective leads to the metal layer 21. In the illustrated first embodiment, the bottom locating plate 2 is a circuit board, and the metal layer 21 is a printed circuit arranged on the circuit board; and the metal layer 21 can be provided on one single sided or on two opposite sides of the circuit board.

The top locating plate 3, to which upper ends of the one or more mounting plates 1 are connected, is provided with a metal layer 31. A plurality of LEDs 4 is welded at respective leads to the metal layers 31. In the illustrated first embodiment, the top locating plate 3 is a circuit board, and the metal layer 31 is a printed circuit arranged on the circuit board; and the metal layer 31 can be provided on one single sided or on two opposite sides of the circuit board. And, the top locating plate 3 and the metal layer 31 are provided with a plurality of tiny perforations 32.

The heat radiating member 5 is located beneath the top locating plate 3, and includes a long metal strip, an end of which is welded to the top locating plate 3 while an opposing end of which is inward wound to form a roll.

As can be seen from FIG. 2, the heat dissipation structure according to the present invention can be assembled to a lamp holder 6. A lamp shade 61 is connected to a top of the lamp holder 6, and a threaded lamp base 62 is formed at a lower part of the lamp holder 6. A plurality of openings 63 is provided on the lamp holder 6 near the lamp shade 61. And, an annular space 64 is formed at a junction between the threaded lamp base 62 and the lamp holder 6, as shown in FIG. 3.

To assemble the heat dissipation structure of the present invention to the lamp holder 6 to form an LED lamp, the bottom locating plate 2 is fixed to the lamp holder 6. When the LEDs 4 are lightened, heat produced by these LEDs 4 during working can be radiated from the metal layers 11, 21, 31 on the mounting plates 1, the bottom locating plate 2 and the top locating plate 3, and from the heat radiating member 5, which together provide a relatively large heat radiating area. Meanwhile, the perforations 32 provided on the top locating plate 3 allow air convection due to relatively hot air and relatively cool air in upper and lower portions, respectively, in the lamp shade 61. The openings 63 and the annular space 64 also allow exchange of air inside and outside the lamp shade 61. With these arrangements, heat produced by the LEDs 4 during working can be effectively dissipated into open air surrounding the LED lamp while the LED lamp has a reduced volume. Moreover, the heat dissipation structure for LED lamp according to the present invention has simple structure and can therefore be produced at reduced cost.

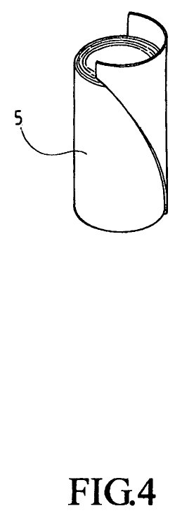

Please refer to FIG. 4, which is a perspective view of the heat radiating member 5 for the present invention. As shown, the heat radiating member 5 includes a long metal strip, an end of which is welded to the top locating plate 3 while the other end of which is spirally wound inward by predetermined turns to form a roll, which occupies a relatively small space. When the heat produced by the working LEDs 4 diffuses along the heat radiating member 5, the large area provided by the spirally wound heat radiating member 5 allows the heat to adequately propagate to thereby enable more uniform temperature distribution in the lamp shade 61 and formation of air turbulence in the LED lamp, and accordingly, increased heat dissipation efficiency.

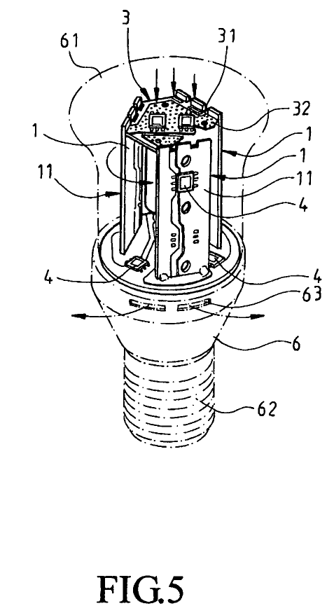

Please refer to FIG. 5 that shows the heat dissipation of the LED lamp with the heat dissipation structure according to the first embodiment of the present invention. As shown, when the LEDs 4 are lightened, three different temperature zones are formed, namely, a low-temperature zone outside the LED lamp, a middle-temperature zone inside the LED lamp, and a high-temperature zone at a top of the LED lamp. The heat produced by the lightened LEDs 4 is radiated from the metal layers 11, 21, 31 of the one or more mounting plates 1, the bottom locating plate 2, and the top locating plate 3 into air inside the lamp shade 61. Meanwhile, the perforations 32 on the top locating plate 3 allow vertical air convection inside the lamp shade 61 in the high-temperature zone and the middle-temperature zone, and the openings 63 and the annular space 64 on the lamp holder 6 allow air exchange between the low-temperature zone and the middle-temperature zone, so that the produced heat is constantly dissipated from the LED lamp to the external environment. The roll-shaped heat radiating member 5 located beneath the top locating plate 3 provides increased area, along which heat propagates to enable even better heat dissipation effect. Since no large-area heat radiating plate is used in the present invention, the LED lamp with the heat dissipation structure of the present invention can have a reduced volume.

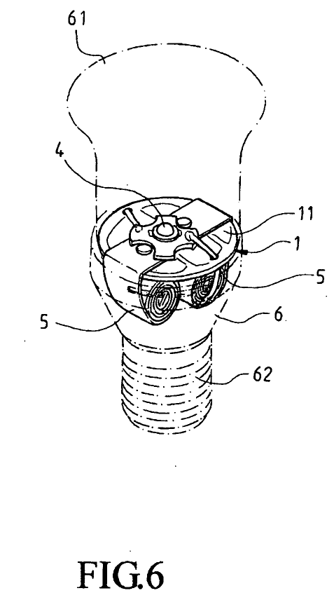

FIG. 6 is a perspective view showing an LED lamp having a heat dissipation structure according to a second embodiment of the present invention assembled thereto. As shown, the heat dissipation structure according to the second embodiment includes a mounting plate 1, on which a metal layer 11 is provided and an LED 4 is welded at leads to the metal layer 11; and two heat radiating members 5 are arranged at two opposite sides of the mounting plate 1. The two heat radiating members 5 each are downward extended from the mounting plate 1 and wound into a roll beneath the mounting plate 1. The roll-shaped heat radiating members 5 provide an increased area, along which the heat produced by the working LED 4 propagates to enable better heat dissipation effect.

In brief, the heat dissipation structure for LED lamp according to the present invention has the following advantages: (1) having simple structure to enable reduced manufacturing cost; (2) providing good heat dissipation effect; and (3) allowing the LED lamp to have reduced volume and accordingly upgraded competing ability in the market.

It is understood the heat dissipation member is not necessarily wound into a roll but can be a long metal strip being, for example, differently folded or bent into a reduced volume while providing a large heat radiating area. Further, the metal layer and the heat radiating member according to a preferred embodiment of the present invention can be copper foil, which provides good heat conductivity and ductility to achieve the heat dissipation function. However, it is understood other metals with good heat conductivity and ductility can also be used in the present invention. Therefore, while the present invention has been described with some preferred embodiments thereof, it is understood that many changes and modifications in the described embodiments can be carried out without departing from the scope and the spirit of the invention that is intended to be limited only by the appended claims.

What is claimed is:

1. A heat dissipation structure for LED lamp, comprising:
a plurality of mounting plates, on each of which a metal layer is provided, and one or more LEDs being welded at respective leads to the metal layers;
a top locating plate being connected to upper ends of the mounting plates and provided with a metal layer, which is provided with a plurality of tiny perforations, and one or more LEDs being welded at respective leads to the metal layer;
a heat radiating member being provided beneath the top locating plate; and
a bottom locating plate for lower ends of the mounting plates to inserted thereinto and being provided with a metal layer, and one or more LEDs being welded at respective leads to the metal layer;
whereby when the heat dissipation structure is assembled to a lamp holder to form an LED lamp by fixing the bottom locating plate to the lamp holder and when the LEDs are lightened, heat produced by the LEDs in working can be radiated from the metal layers on the mounting plates, the bottom locating plate and the top locating plate, and from the heat radiating member, which together provide a relatively large heat radiating area; meanwhile, the perforations provided on the top locating plate allow convection of air in the LED lamp and openings provided on the lamp holder allow exchange of air inside and outside the LED lamp, allowing the LED lamp to have reduced volume, increased heat dissipation efficiency, and reduced manufacturing cost.

2. The heat dissipation structure for LED lamp as claimed in claim 1, wherein the mounting plates and the top and bottom locating plates are circuit boards, and the metal layers are printed circuits arranged on the circuit boards.

3. The heat dissipation structure for LED lamp as claimed in claim 1, wherein the metal layers are provided on one side or two opposite sides of the mounting plates and the top and bottom locating plates to provide increased heat radiating area.

4. The heat dissipation structure for LED lamp as claimed in claim 1, wherein the heat radiating member provided beneath the top locating plate is a long strip wound into a roll to provide increased heat radiating area.

5. The heat dissipation structure for LED lamp as claimed in claim 1, wherein one of the heat radiating member and the metal layers is copper foil to provide increased heat dissipation efficiency.

6. A heat dissipation structure for LED lamp, comprising:
a mounting plate having a metal layer provided thereon, one or more LEDs being welded at respective leads to the metal layer, and the metal layer being provided with a plurality of tiny perforations; and
a heat radiating member being downward extended from the metal layer of the mounting plate;
whereby when the heat dissipation structure is assembled to a lamp holder to form an LED lamp by fixing the mounting plate to the lamp holder and when the LEDs are lightened, heat produced by the LEDs in working can be radiated from the metal layer on the mounting plate and from the heat radiating member, which together provide a relatively large heat radiating area while allowing the LED lamp to have reduced volume, increased heat dissipation efficiency and reduced manufacturing cost.

7. The heat dissipation structure for LED lamp as claimed in claim 6, wherein the heat radiating member downward extended from the mounting plate is a long strip wound into a roll to provide increased heat radiating area.

8. The heat dissipation structure for LED lamp as claimed in claim 6, wherein one of the heat radiating member and the metal layer is copper foil to provide increased heat dissipation efficiency.
